(19) United States
(12) Patent Application Publication
(10) Pub. No.: US 2019/0166803 A1
(43) Pub. Date: Jun. 6, 2019

(54) BIRD FEEDER WITH SQUIRREL RESISTING FEATURES

(71) Applicant: DUDLEY BARTHOLOW, INDEPENDENCE, MN (US)

(72) Inventor: DUDLEY BARTHOLOW, INDEPENDENCE, MN (US)

(21) Appl. No.: 15/993,176

(22) Filed: May 30, 2018

Related U.S. Application Data
(60) Provisional application No. 62/512,783, filed on May 31, 2017.
(60) Provisional application No. 62/529,162, filed on Jul. 6, 2017.

(51) Int. Cl. A01K 39/01; A01K 39/012

(52) U.S. Cl. CPC A01K 39/0113; F16M 13/02; A01K 39/012

(57) ABSTRACT

A birdfeeder apparatus for discouraging squirrels from accessing birdfeed in the birdfeeder apparatus may comprise a feed holder configured to contain a quantity of birdfeed and having a perimeter wall with an upper portion and a lower portion, with the upper portion and the lower portion of the feed holder each having a width. The apparatus may also comprise at least one feed opening being located on the lower portion and extending through the perimeter wall of the feed holder, and a perch configured to support a bird feeding at the at least one feed opening, with the perch being located adjacent to the at least one feed opening on the lower portion of the perimeter wall and extending outwardly from the perimeter wall. The width of the upper portion may be larger than the width of the lower portion.

### REFERENCE TO RELATED APPLICATIONS

This application claims the benefits of U.S. Provisional Patent Application No. 62/512,783, filed May 31, 2017, and U.S. Provisional Patent Application No. 62/529,162, filed Jul. 5, 2017, each of which is hereby incorporated by reference in their entireties.

### BACKGROUND

### Field

The present disclosure relates to bird feeders and more particularly pertains to a new bird feeder with squirrel resisting features for frustrating the attempts of squirrels to gain useful paw-holds on the feeder or descend down onto the perches of the feeder.

### SUMMARY

In one aspect, the present disclosure relates to a birdfeeder apparatus for discouraging squirrels from accessing birdfeed in the birdfeeder apparatus. The birdfeeder apparatus may comprise a feed holder configured to contain a quantity of birdfeed and having a perimeter wall with an upper portion and a lower portion, with the upper portion and the lower portion of the feed holder each having a width. The apparatus may also comprise at least one feed opening being located on the lower portion and extending through the perimeter wall of the feed holder, and may also include a perch configured to support a bird feeding at the at least one feed opening. The perch may be located adjacent to the at least one feed opening on the lower portion of the perimeter wall and extending outwardly from the perimeter wall. The width of the upper portion may be larger than the width of the lower portion such that substantially an entirety of the perch is positioned below the upper portion of the feed holder.

There has thus been outlined, rather broadly, some of the more important elements of the disclosure in order that the detailed description thereof that follows may be better understood, and in order that the present contribution to the art may be better appreciated. There are additional elements of the disclosure that will be described hereinafter and which will form the subject matter of the claims appended hereto.

In this respect, before explaining at least one embodiment or implementation in greater detail, it is to be understood that the scope of the disclosure is not limited in its application to the details of construction and to the arrangements of the components set forth in the following description or illustrated in the drawings. The disclosure is capable of other embodiments and implementations and is thus capable of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present disclosure. It is important, therefore, that the claims be regarded as including such equivalent constructions insofar as they do not depart from the spirit and scope of the present disclosure.

The advantages of the various embodiments of the present disclosure, along with the various features of novelty that characterize the disclosure, are disclosed in the following descriptive matter and accompanying drawings.

### BRIEF DESCRIPTION OF THE DRAWINGS

The disclosure will be better understood and when consideration is given to the drawings and the detailed description which follows. Such description makes reference to the annexed drawings wherein:

FIG. 1 is a schematic side view of a new bird feeder apparatus with squirrel resisting features according to the present disclosure.

FIG. 2A is a schematic side view of a section of the upper portion with one configuration of the upper surface of the upper portion, according to an illustrative embodiment.

FIG. 2B is a schematic side view of a section of the upper portion with another configuration of the upper surface of the upper portion, according to an illustrative embodiment.

FIG. 2C is a schematic side view of a section of the upper portion with a further configuration of the upper surface of the upper portion, according to an illustrative embodiment.

FIG. 3 is a schematic side view of a lower section of the upper portion, the transition portion, and the lower portion of an optional configuration of the feed holder, according to an illustrative embodiment.

FIG. 4 is a schematic side view of an optional feeder cap mounted on a bird feeder, according to an illustrative embodiment.

FIG. 5 is a schematic exploded side view of an optional feeder cap configuration and a top section of a bird feeder, according to an illustrative embodiment.

FIG. 6 is a schematic side view of the suspending structure of the bird feeder apparatus, according to an illustrative embodiment.

FIG. 7 is a schematic side view of a feeder bottom end, according to an illustrative embodiment.

FIG. 8 is a schematic side view of a lower extent of the feed holder with a feed tray, according to an illustrative embodiment.

FIG. 9 is a schematic side sectional view of a lower portion of the feed holder showing detail of the perch devices, according to an illustrative embodiment.

FIG. 10 is a schematic perspective view of a lower fill cap for the feed holder, according to an illustrative embodiment.

FIG. 11 is a partial sectional view of the lower fill cap, the lower portion of the perimeter wall, and the perch device of the feed holder, according to an illustrative embodiment.

### DETAILED DESCRIPTION

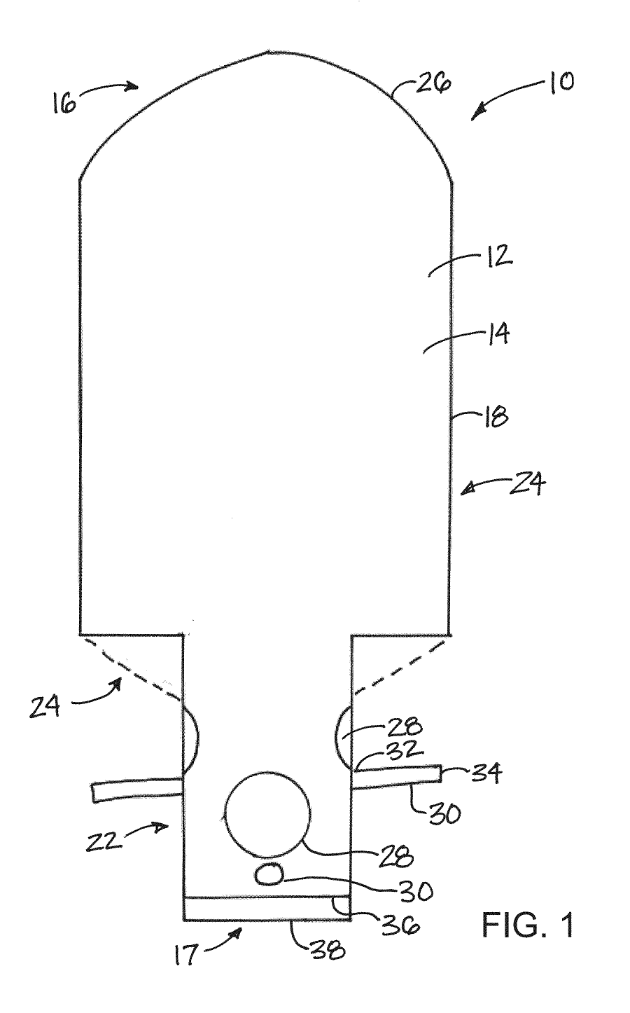

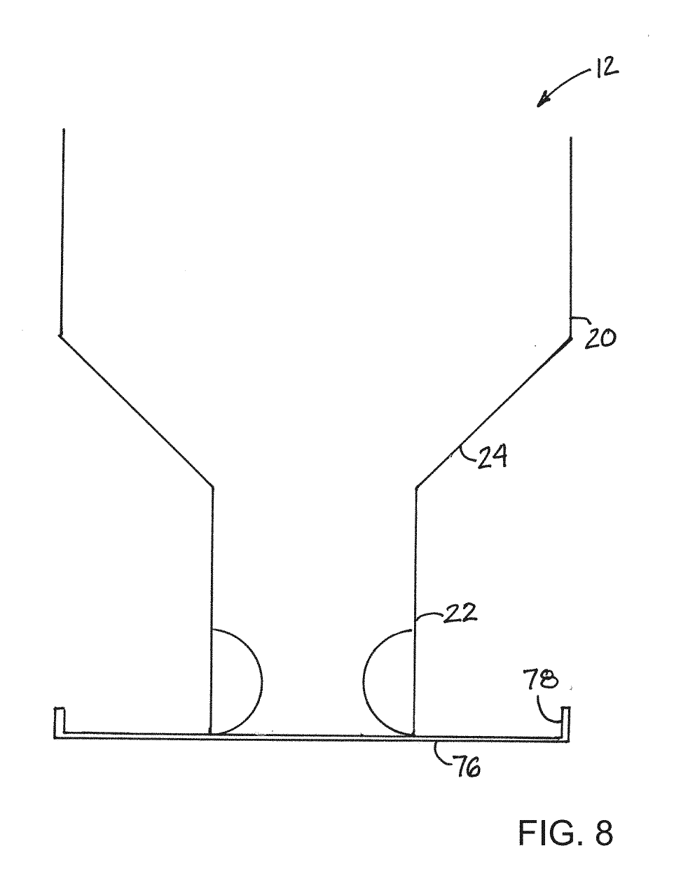

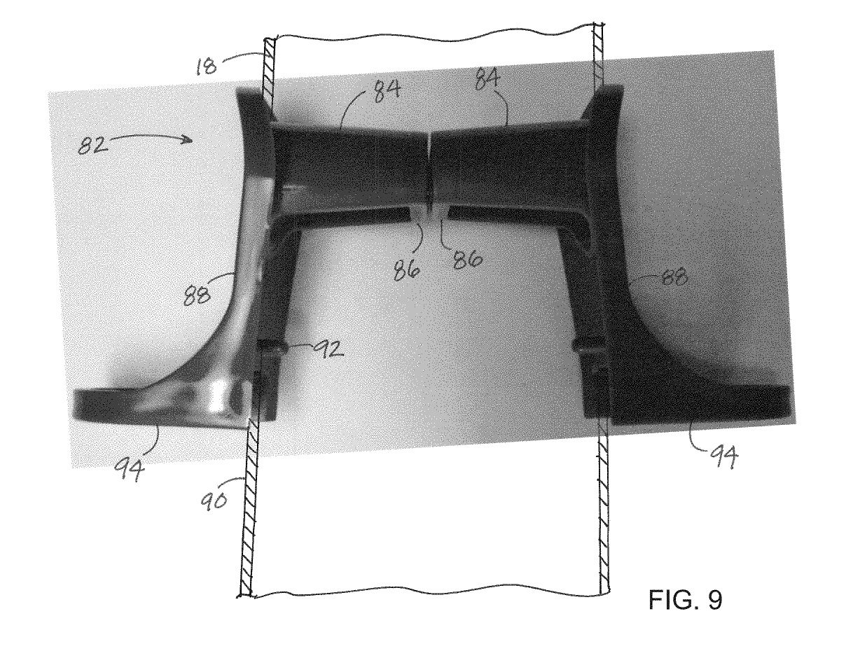

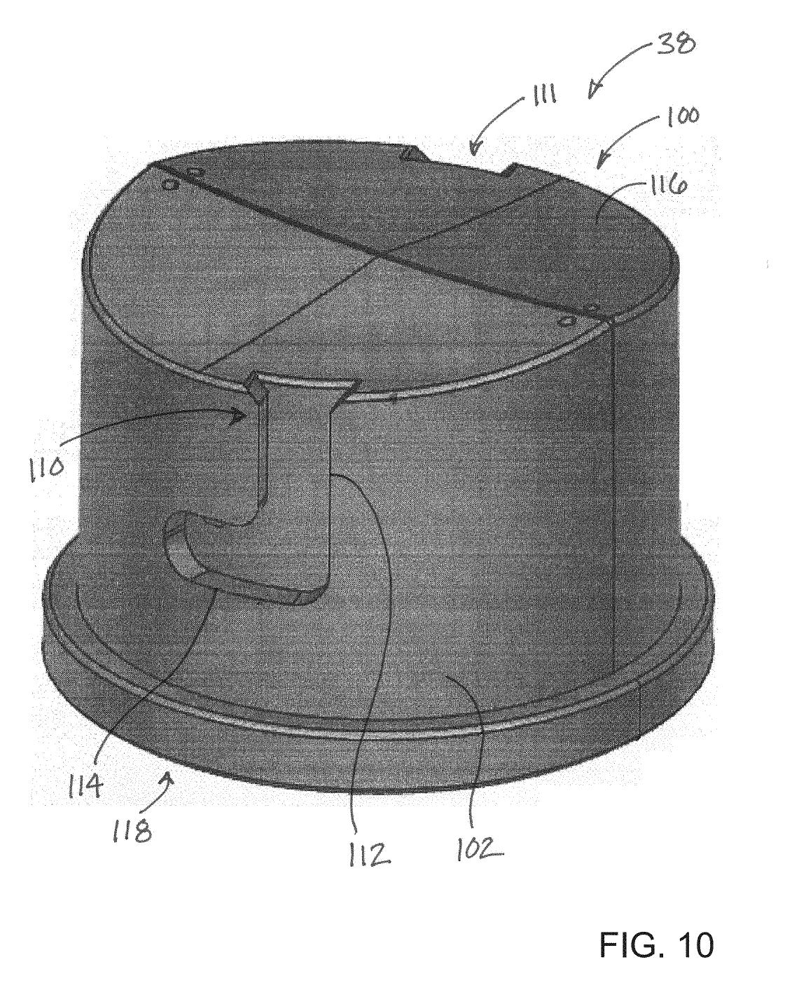

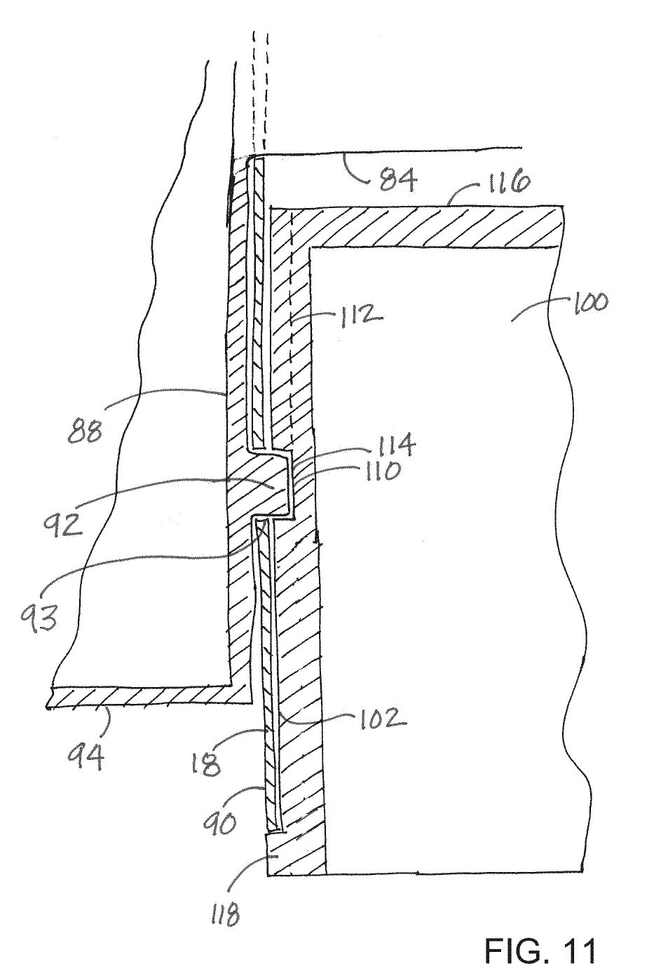

With reference now to the drawings, and in particular to FIGS. 1 through 11 thereof, a new bird feeder with squirrel resisting features embodying the principles and concepts of the disclosed subject matter will be described.

The disclosure relates to a birdfeeder apparatus 10 for discouraging animals, and in particular rodents such as squirrels, from accessing bird feed located in (and dispensed by) the birdfeeder apparatus. The disclosure also relates to various structures that may be utilized with various other birdfeeder apparatus to achieve some of the advantages and benefits of the disclosure.

The birdfeeder apparatus 10 may include a feed holder 12 which may define an interior 14 for holding a quantity of bird feed and which may make the bird feed accessible to birds. The feed holder 12 may have an upper end 16 and a lower end 17 with the upper end being located relatively higher than the lower end when the apparatus 10 is in the normal orientation for use. The feed holder 12 may have a length defined between the upper 16 and lower 17 ends. The feed holder 12 may be substantially hollow to define the interior 14 for containing the bird feed. The feed holder 12 may include a perimeter wall 18 which may be formed by a substantially rigid material, and may be formed by a substantially transparent material to permit viewing of the contents of the holder to determine the need to add additional feed.

The feed holder 12 may comprise an upper portion 20 which is located toward the upper end 16 of the feed holder and a lower portion 22 located toward the lower end 17 of the feed holder. In some embodiments, a transition portion 24 may be positioned or located between the upper 20 and lower 22 portions of the feed holder, and may function to join the lower portion 22 to the upper portion 20. The upper 20 and lower 22 portions may each have a width measured in a direction oriented substantially perpendicular to the length of the feed holder. In some embodiments, the perimeter wall 18 may have a substantially cylindrical shape and the width of each of the upper and lower portions may comprise a diameter, although other cross sectional shapes may be employed for the holder. For example, the perimeter wall, and the corresponding upper and lower portions, may each have a cross sectional configuration of rectangular or square or other polygonal shape.

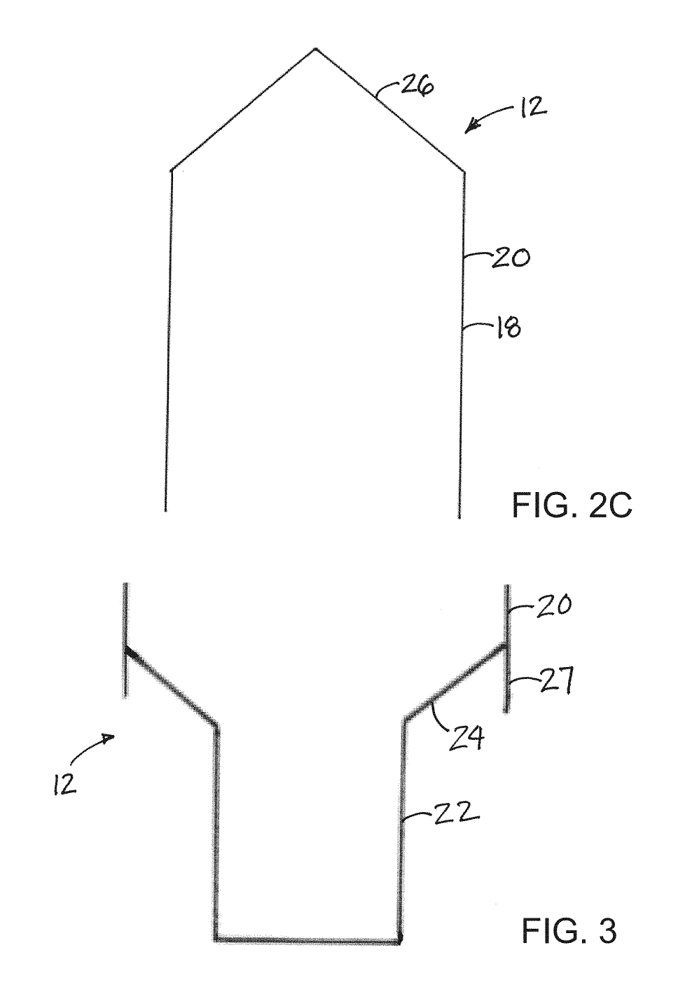

Significantly, in some embodiments the upper portion and the lower portion have different widths, with the width of the upper portion being larger than the width of the lower portion. The transition portion 24 may extend between the relatively larger width of the upper portion and the relatively smaller width of the lower portion. In embodiments of the holder 12 with cylindrical shapes, the diameter of the upper portion may be relatively larger than the diameter of the lower portion. The transition portion 24 may thus form an overhang of the upper portion with respect to the lower portion. In some embodiments, the transition portion 24 may have a substantially frustrated conical shape (shown in broken lines in FIG. 1), and in some embodiments the transition portion may have an annular disk shape (shown in solid lines in FIG. 1). Optionally, the transition portion of the wall may even slope inwardly and upwardly from the upper portion to the lower portion, or even upwardly and inwardly and then downwardly and inwardly to the lower portion. In some embodiments, a skirt section 27 of the perimeter wall (see FIG. 3) may extend downwardly from the upper portion past the uppermost extent of perimeter wall forming the transition portion to further frustrate the efforts of the squirrels attempting to grab onto structures on the lower portion of the feed holder.

At least one feed opening 28 may be provided on the feed holder 12, and may be located on the lower portion 22. In some embodiments, a plurality of feed openings may be provided. The one or more feed openings 28 may extend through the perimeter wall 18 of the feed holder such that feed held in the interior 14 of the feed holder is able to pass through the perimeter wall, such as through the actions or activity of feeding birds. The plurality of feed openings 28 may be located on the perimeter wall at substantially equal spacings or separations from each other, such as about the circumference of the lower portion.

The birdfeeder apparatus 10 may also include a perch 30 for supporting a bird feeding at the at least one feed opening may also be provided. The perch 30 may be located adjacent to one of the feed openings 28, and each opening may have a perch associated with it. The perch may be mounted on the perimeter wall 18 and may extend radially outwardly from the exterior surface of the perimeter wall in a substantially horizontal orientation. The perch 30 may have an inner end 32 which is located adjacent to the perimeter wall and may be mounted on the perimeter wall, The perch may also have an outer end 34 which is located opposite of the inner end 32, and may be a free end. The perch 30 may have a length between the inner 32 and outer 34 ends.

Significantly, the length of the perch 30 may be configured such that a significant portion, or even an entirety, of the length of the perch 30 is positioned below the upper portion 20 of the feed holder and as well as the transition portion 24 if present. The perch may not extend, or may not extend to an appreciable degree, beyond the vertical plane of the upper portion of the perimeter wall at the location of the perch. Illustratively, some embodiments of the feed holder may have an upper portion 20 with a diameter or width of approximately 6 inches to approximately 7 inches, while the lower portion 22 may have a diameter or width of approximately 2 inches to approximately 3 inches, although other sizes may also be used.

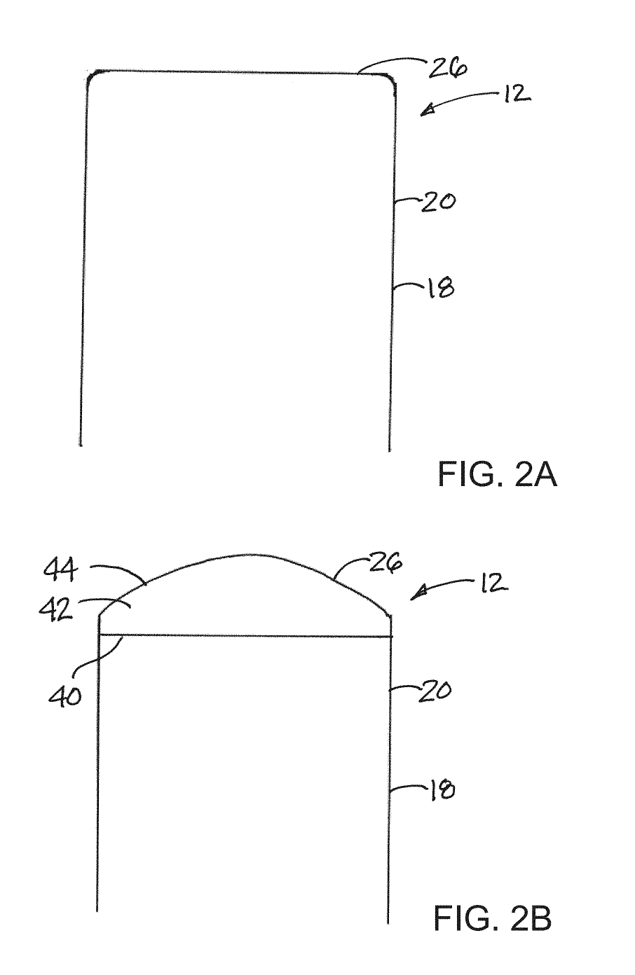

In some embodiments of the apparatus 10, the upper end 16 of the feed holder 12 may be configured to resist gripping of the upper end by the paw of a rodent such as a squirrel, and may have a shape that squirrels cannot easily and reliably jump to and land on to use as a platform for attempting to reach the seed dispensing openings below. The upper end of the feed holder may have an upper surface 26 with a shape which resists or prevents the gripping of the upper surface by the claws of the squirrel. In some embodiments, the upper surface 26 may have a dome shaped wall (see FIG. 2B). In some other embodiments, the upper surface 26 may have an inverted cone or conical shape (see FIG. 2C) that tapers narrower in an upward direction. In some further embodiments, the upper surface 26 of the feed holder may have a flat or planar shape which lacks any protruding edge (see FIG. 3C) which might provide a paw-hold for a squirrel, and may be slightly rounded at the location where the upper surface of the top wall meets the outer surface of the perimeter wall. The diameter of the upper portion 20 may also be large enough that squirrels of typical size are unable to embrace and hold onto a substantial enough portion of the outer surface of the perimeter wall to support themselves.

In some embodiments of the apparatus 10, a fill opening may be formed on the feed holder 12 to permit filling of feed into the interior 14 of the holder 12. A filler cap may also be removably mounted on the feed holder to selectively close the fill opening, and the filler cap may be generally horizontally oriented when the apparatus 10 is oriented for use. Illustratively, a fill opening 36 may be located on the lower end 17 of the feed holder such that the feed holder may be inverted to fill the feed holder through the opening 36 (see FIG. 1). A filler cap 38 may be mounted on the lower end 17 of the feed holder in order to selectively close the fill opening 36. The upper end 16 of the feed holder may be permanently closed against opening or removal of portions that would permit filling of the interior. Such a configuration may be useful in eliminating from the upper end 16 of the feed holder structure that would aid the gripping of the feed holder by the paws of a squirrel.

In other embodiments, the fill opening may comprise an upper fill opening 40 which is located at the upper end 16 of the feed holder (see FIG. 2B), and the filler cap may comprise an upper filler cap 42 which is mountable on the upper end 16 of the feed holder to selectively close the fill opening. The upper filler cap 42 may have an upper surface 44, and the upper surface may have a dome shape, or an inverted cone or conical shape, or even a flat shape which lacks a protruding edge which may provide a paw-hold for a squirrel. The upper filler cap 42 may be removably mounted on the perimeter wall 18 of the feed holder in any suitable manner, such as, for example, through the use of complementary threads on the cap 42 and the perimeter wall 18, or through the use of guide wires that extend from the perimeter wall to guide the movement of a cap between a closed position against the perimeter wall, and an open position away from the upper fill opening 40 of the perimeter wall, or through the use of a “snap on/snap off” type of interference relationship between the cap and wall 18, or other suitable structure.

Optionally, one or more vents 46 may be provided for ventilating the interior 14 of the feed holder 12, and the vent or vents may be formed on the upper portion 20 of the feed holder toward the uppermost portion of the perimeter wall 18. In some embodiments, the vent 46 may be located just below the position of the upper fill cap 42 when the cap is mounted on the body. As a further option, the vent or vents 46 may be formed on the cap itself.

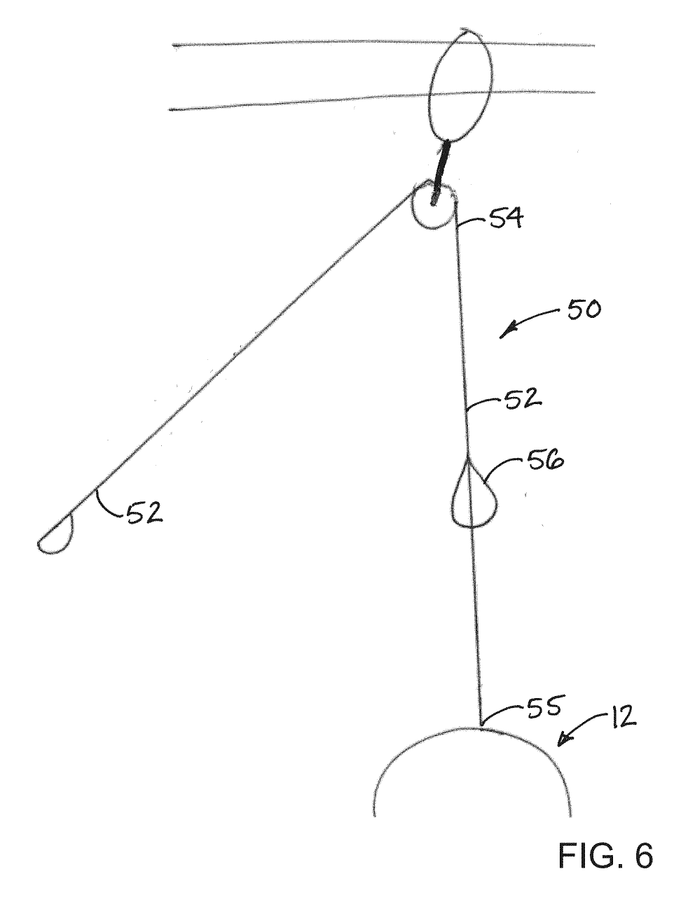

The apparatus 10 may also include a suspending structure 50 (see FIG. 6) which is configured to suspend the feed holder 12 from a support located above the feed holder. The suspending structure 50 may comprise an elongate member 52 which may have an upper end 54 and a lower end 55. The elongate member 52 may comprise a cord or cable or other relatively thin and flexible structure capable of resisting a degree of tension to support the feed holder without any significant stretching.

In some embodiments, a portion of the elongate member 52 may be formed into a loop 56 and the loop may be located above the feed holder when the feed holder is suspended by the elongated member from the support. To accomplish this, the feed holder 12 may be inverted or substantially inverted and a portion of the feed holder may be inserted into the loop 56 to thereby hold the feed holder in an inverted condition for filling of the interior of the feed holder. A feed holder having a lower fill opening 36 with a lower filler cap 38 may be utilized in combination with the loop 56 such that upon inverting and inserting the feed holder into the loop, the lower filler cap 38 may be removed from the lower fill opening 36 and a quantity of bird feed may be moved through the lower fill opening 36 to fill the interior. Once the desired quantity of bird feed has been dispensed into the interior 14 through the lower fill opening 36, the lower filler cap 38 may be re-mounted on the lower end 17 of the feed holder and the feed holder may be removed from the loop 56 such that the feed holder is able to be suspended in the normal upright orientation for use. In some embodiments, a pulley may be positioned above the feed holder and may receive a portion of the elongate member 52 to permit the elongate member to move through the pulley and relative to the support positioned above the feed holder to raise and lower the vertical height of the feed holder as needed.

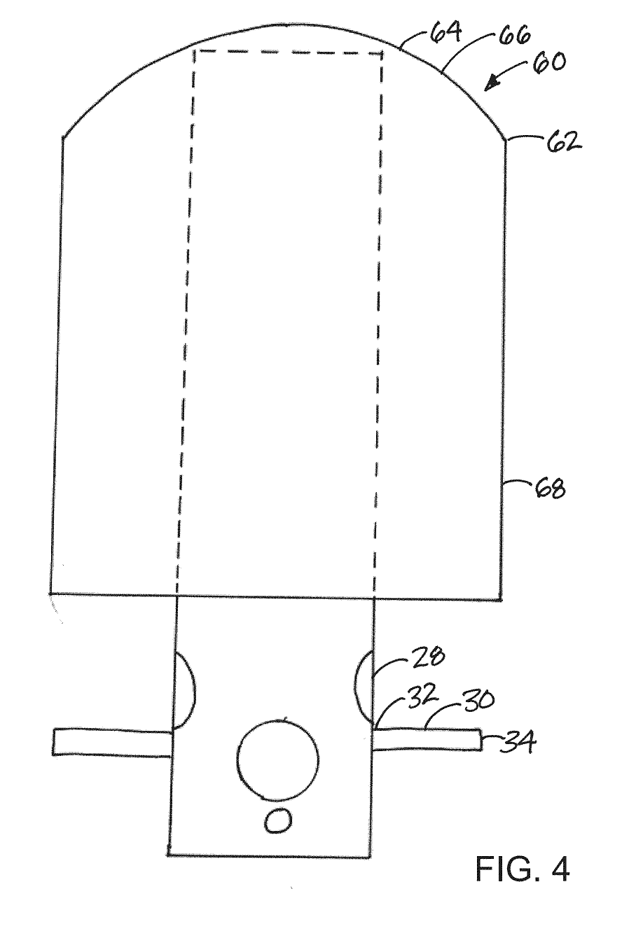

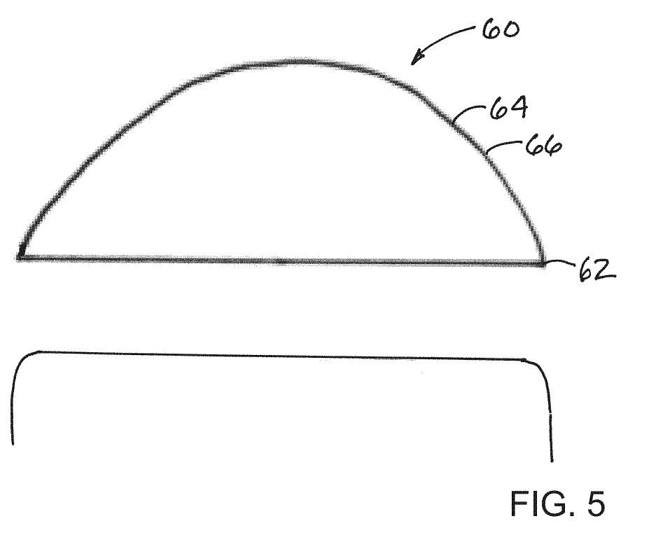

In other aspects of the disclosure a feeder cap 60 may be utilized for providing some of the benefits and advantages of the design of the disclosed feed holder to other feed holders as a retrofitted feature (see FIGS. 4 and 5). The feeder cap 60 may be mountable on an upper end of a bird feeder lacking these features as manufactured. The feeder cap 60 may have an outer perimeter 62 with a width, and in some embodiments the outer perimeter may have a circular shape and the width may comprise a diameter. The width of the outer perimeter 62 may be substantially equal to, or preferably larger than, the width of the bird feeder, such as the feed holder element of the bird feeder. The feeder cap 60 may have an upper surface 64, and the upper surface may have a dome shape, or in inverted cone or conical shape, or even a flat shape which lacks a protruding edge that may provide a paw-hold for squirrel. The feeder cap 60 may include a top wall 66 which has the outer perimeter as well as the upper surface 64, and a perimeter wall 68 which may extend generally downwardly from the outer perimeter of the top wall (see FIG. 4). The feeder cap may be mounted on the top of the feeder in any suitable manner, such as by mechanical fastening or bonding by an adhesive or adhesive structure.

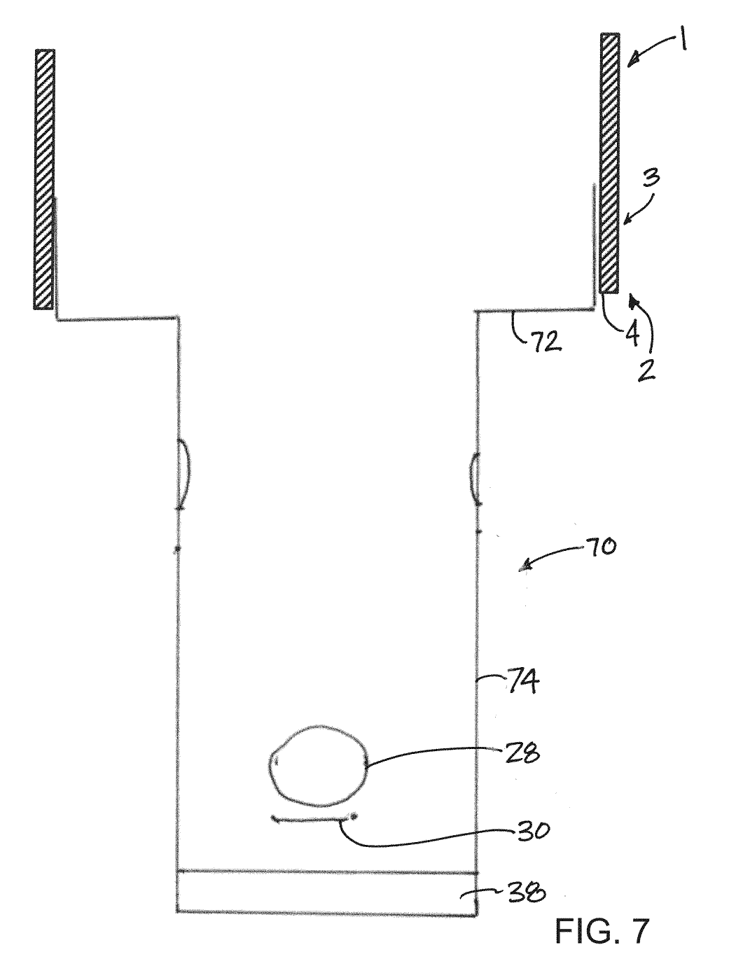

In other optional embodiments, a feeder bottom end 70 (see FIG. 7) may be provided for mounting on the lower end of a tubular structure 1. The feeder bottom end 70 may include an upper transition portion 72 for mounting to a lower section 3 of the tubular structure located at a lower opening for of the tubular structure to thereby close the lower opening. The upper transition portion 72 may have a width which is substantially equal to the width of the lower end 2 of the tubular structure. The feeder bottom end 70 may also include a lower portion 74 located below the upper transition portion 72. The lower portion 74 may have a width that is less than the upper transition portion 72, and may also have at least one feed opening at least one perch being provided on the lower portion adjacent to the feed opening.

The feed openings, and the associated perches, are formed on the lower portion and for the most part are tucked underneath the larger upper portion so that a squirrel sliding down or falling along the outer surface of the upper portion may slide right past the perches since the perches do not protrude significantly with respect to the outer surface of the upper portion.

In some embodiments, a feed tray 76 may be located toward the lower end 17 of the feed holder, such as at the lower end, and may be attached to the lower end. The feed tray 76 may have a generally upstanding perimeter lip 78 for helping to keep feed (e.g., seeds) on the feed tray until consumed by a bird. The feed tray 76 may extend outwardly from the lower portion 22 of the feed holder, and more specifically may extend outwardly in at least two opposite directions from the lower portion. The feed tray 76 may have an extent measured in the opposite directions. In some embodiments, the extent may be configured such that, or characterized by the fact that, all, or substantially all, of the extent of the tray does not extend, or does not extend to an appreciable degree, beyond the vertical plane of the perimeter wall of the upper portion 20 of the perimeter wall 18 of the feed holder. The perimeter shape of the tray 76 may be of any suitable shape, and may correspond to the shape of the horizontal cross section of the perimeter wall of the upper portion of the feed holder.

In some embodiments, the perch 30 may comprise a perch device 82 which is configured to be at least partially inserted into one of the feed openings 28 of the feed holder 12 and provide a perch or rest for a bird accessing feed through the feed opening. The perch device may include a feed diverter portion 84 which is insertable through the feed opening 28 into the interior 14 of the feed holder. The feed diverter portion 84 may have an interior and 86 which may be fully inserted into the interior and may be configured to abut against the interior and of a feed diverter portion of a second perch device inserted through a second feed opening located on an opposite side of the perimeter wall 18 from the first feed opening. The interior ends of the feed diverter portions of the devices may be abuttable and connectable together using a suitable fastener which thereby holds the perch device is in position on the perimeter wall. Each perch device may also include a wall abutment portion 88 which is configured to abut against an outer surface 90 of the perimeter wall of the feed holder when the feed diverter portion 84 is inserted through the feed opening. The wall abutment portion 88 may be configured to frame or otherwise surround the feed opening in the perimeter wall. The wall abutment portion 88 may include an engagement peg 92 which is configured to insert through a positioning hole 93 when the feed diverter portion is inserted through the feed opening. The perch device 82 may also include a perch portion 94 which extends outwardly from the wall abutment portion 88 four extending outwardly from the perimeter wall of the feed holder when the feed diverter portion is inserted through the feed opening.

In some embodiments, the lower fill cap may include an insert portion 100 which is configured to insert into the interior 14 of the feed holder through the lower fill opening 36 of the feed holder. The insert portion 100 may have an outer surface 102 four being positioned adjacent to the perimeter wall when the insert portion is inserted into the interior. A locking slot 110 may be configured to receive a portion of the engagement peg 92 of the wall abutment portion 88 of the perch device which extends through the positioning hole 93 in the perimeter wall when the perch is mounted on the feed holder. The locking slot 110 may be formed in the outer surface of the insert portion, and may have an entry portion 112 and a locking portion 114 with the locking portion being oriented substantially perpendicular to the entry portion. The entry portion 112 may be in communication with a top and 116 of the insert portion. In some embodiments, a pair of the locking slots 110, 111 may be formed in the outer surface, and may be located on substantially opposite sides of the insert portion. During mounting of the lower fill cap on the perimeter wall, the insert portion 100 may be inserted through the lower fill opening and may be rotated to align the engagement peg or pegs 92 of the perch device or devices with the entry portion 112 of the locking slot. The insert portion may be can continue to be moved into the interior until the engagement peg reaches the end of the entry portion, whereupon rotation of the lower fill cap tends to move the engagement peg 92 into the locking portion 114 of the slot to thereby secure the lower fill cap on the perimeter wall in the condition that closes the lower fill opening 36. The lower fill cap may be removed by rotating the cap such that the engagement peg moves through the locking portion to reach the entry portion, whereupon the insert portion may be withdrawn from the interior by a generally linear movement of the portion 100 with respect to the perimeter wall.

In some embodiments, the lower fill cap may also include a lip portion 120 which extends radially outwardly from some or all of the circumference of the insert portion such that the lid portion 120 abuts against a lower edge of the perimeter wall to thereby limit the degree of insertion of the insert portion into the interior of the feed holder.

It should be appreciated that in the foregoing description and appended claims, that the terms “substantially” and “approximately,” when used to modify another term, mean “for the most part” or “being largely but not wholly or completely that which is specified” by the modified term.

It should also be appreciated from the foregoing description that, except when mutually exclusive, the features of the various embodiments described herein may be combined with features of other embodiments as desired while remaining within the intended scope of the disclosure.

With respect to the above description then, it is to be realized that the optimum dimensional relationships for the parts of the disclosed embodiments and implementations, to include variations in size, materials, shape, form, function and manner of operation, assembly and use, are deemed readily apparent and obvious to one skilled in the art in light of the foregoing disclosure, and all equivalent relationships to those illustrated in the drawings and described in the specification are intended to be encompassed by the present disclosure.

Therefore, the foregoing is considered as illustrative only of the principles of the disclosure. Further, since numerous modifications and changes will readily occur to those skilled in the art, it is not desired to limit the disclosed subject matter to the exact construction and operation shown and described, and accordingly, all suitable modifications and equivalents may be resorted to that fall within the scope of the claims.

I claim:

1. A birdfeeder apparatus for discouraging squirrels from accessing birdfeed in the birdfeeder apparatus, the apparatus comprising:
a feed holder configured to contain a quantity of birdfeed, the feed holder having a perimeter wall with an upper portion and a lower portion, the upper portion and the lower portion of the feed holder each having a width;
at least one feed opening being located on the lower portion and extending through the perimeter wall of the feed holder;
a perch configured to support a bird feeding at the at least one feed opening, the perch being located adjacent to the at least one feed opening on the lower portion of the perimeter wall and extending outwardly from the perimeter wall; and
wherein the width of the upper portion is larger than the width of the lower portion such that substantially an entirety of the perch is positioned below the upper portion of the feed holder.

2. The apparatus of claim 1 wherein the perch has an inner end adjacent to the perimeter wall and an outer end opposite of the inner end, the perch having a length between the inner and outer ends such that the outer end is positioned under the upper portion.

3. The apparatus of claim 1 wherein the perch comprises a perch device configured to be at least partially inserted into one of the feed openings, the perch including:
a feed diverter portion insertable through the feed opening into the interior;
a wall abutment portion including an engagement peg configured to insert through a positioning hole in the perimeter wall when the feed diverter portion is inserted through the feed opening;
a perch portion extending outwardly from the wall abutment portion for extending outwardly from the perimeter wall of the feed holder when the feed diverter portion is inserted through the feed opening;
a fill opening formed on the lower portion of the perimeter wall to permit filling of feed into the interior of the feed holder;
a filler cap removably mounted on the feed holder to selectively close the fill opening;
wherein the filler cap includes an insert portion configured to at least partially insert into the interior of the feed holder through the fill opening, the insert portion having an outer surface for being positioned adjacent to the perimeter wall when the insert portion is inserted into the interior, a locking slot being formed on the outer surface and being configured to receive a portion of the engagement peg of the wall abutment portion of the perch extending through the positioning hole in the perimeter wall to releasably lock the filler cap in a closing position on the lower portion of the perimeter wall.

4. The apparatus of claim 3 wherein the locking slot has an entry portion and a locking portion, the entry portion being in communication with a top end of the insert portion to permit movement of the engagement peg into the slot during initial insertion of the insert portion into the fill opening, and the locking portion being oriented substantially perpendicular to the entry portion to permit rotation of the insert portion with respect to the engagement peg to lock the insert portion of the filler cap in the fill opening.

5. The apparatus of claim 4 wherein a pair of the locking slots are formed on the outer surface of the insert portion.

6. The apparatus of claim 1 wherein an upper end of the upper portion of the feed holder is configured to resist gripping of the upper end by a squirrel.

7. The apparatus of claim 6 wherein the upper end of the feed holder has an upper surface with a dome shape.

8. The apparatus of claim 6 wherein the upper end of the feed holder has an upper surface with an inverted cone shape.

9. The apparatus of claim 6 wherein the upper end of the feed holder has an upper surface with a flat shape without a protruding edge to provide a paw-hold for a squirrel.

10. The apparatus of claim 1 wherein a fill opening is located at an upper end of the perimeter wall, and a filler cap is mounted on the upper end of the feed holder to selectively close the fill opening.

11. The apparatus of claim 10 wherein the filler cap has an upper surface having a dome shape.

12. The apparatus of claim 10 wherein the filler cap has an upper surface having an inverted cone shape.

13. The apparatus of claim 10 wherein the filler cap has an upper surface having a flat shape without a protruding edge to provide a paw-hold for a squirrel.
